(19) United States
(12) Patent Application Publication
(10) Pub. No.: US 2013/0205629 A1
(43) Pub. Date: Aug. 15, 2013

(54) LABELS

(71) Applicants: Fiona Hird, Wigton (GB); Shalendra Singh, Wigton (GB)

(72) Inventors: Fiona Hird, Wigton (GB); Shalendra Singh, Wigton (GB)

(73) Assignee: INNOVIA FILMS LIMITED, Wigton, Cumbria (GB)

(21) Appl. No.: 13/576,879

(22) PCT Filed: Apr. 8, 2011
(86) PCT No.: PCT/GB2011/050704

§ 371 Date: Feb. 20, 2013

(30) Foreign Application Priority Data
Apr. 14, 2010 (GB) 1006211.5

(51) Int. Cl. G03G 7/00; B32B 27/32; B32B 27/36; B32B 27/08

(52) U.S. Cl. CPC G03G 7/00; B32B 27/08; B32B 27/32; B32B 27/36
USPC 40/638; 40/675; 264/173.12

(57) ABSTRACT

An inherently ink printable multi-layer labelstock film having a substrate core layer comprising a polymeric material and at least one skin layer which is ink printable, the ink printable skin layer comprising a copolyester.

This application claims priority from the GB application 1006211.5, filed Apr. 14, 2010.

### FIELD

The present invention relates to an inherently printable labelstock film having good ink adhesion properties, and relates more particularly to an improved inherently printable film having good ink adhesion properties in the absence of any topcoat to the film, and to labels made therefrom. The present invention also relates to processes for producing such films.

### BACKGROUND

In recent years, diversification of printed products has required printing on a wide variety of materials in sheets; for example papers, synthetic papers, polymer films such as thermoplastic resin films, metallic foils, metallised sheets, etc. These printed items are printed by methods such as offset printing, gravure, flexography, screen press printing and letter press printing. Commonly, inkjet printing is now used to print directly onto the surface of various types of polymer film, such as polyester film for example.

This invention is particularly concerned with polyolefinic films for use in label and certain graphic arts applications. It is believed that polyolefinic films may provide an environmentally friendly alternative to PVC films which are commonly used in labels and graphic arts applications at present.

Uncoated PVC film has been used as a film substrate for printing but has other disadvantages as a substrate for applications such as graphic arts or labels. However, many non-PVC films are not very receptive to common inks such as solvent based inks, used for example in inkjet printing and UV inks, used for example in flexo and screen printing. It would be desirable to provide an inherently printable non-PVC film substrate, such as a polyolefinic film substrate (e.g. a polyethylene or polypropylene film substrate) which provides some or all of those properties desired in an ink printable surface. It would also be desirable to provide such a film substrate which utilises lower amounts of polymeric materials than existing non-PVC films.

Due to the constraints imposed on the ink characteristics due to the nature of the various printing processes, such as flexo, screen and inkjet processes, this latter whether in a thermal or piezo inkjet printer, it is preferable that ink receiving surface of the substrate is modified rather than the ink itself to optimise some or all of the desired properties in the final printed image.

Some of the criteria that an ideal ink receptive substrate will possess include some or all of the following, depending on the particular application (e.g. for a ‘no-label’ look transparency is important rather than whiteness or opacity). A suitable ink printable substrate will have good optical properties such as brightness, whiteness, gloss, opacity and/or colour range to give high-quality images. The substrate should be compatible with components in the ink to ensure that the final ink image has sufficient fastness and low tendency to fade, for example when exposed to UV light. The absorbency of the film surface is important. Some printing processes place special demands on the substrate which is printed with a large amount of liquid, and yet is expected to dry quickly without changing size or shape. Although paper fibres absorb liquid well, they swell and deform resulting in surface imperfections and such moisture-induced undulations have a detrimental effect on image quality. Paper is also unsuitable for many applications as described herein. A suitable substrate will be durable, in that it will maintain its structure for the time of the print. Desirable properties of such a film therefore include dimensional stability, tear resistance, thermal stability, and water and light resistance. Thus to produce a good image the ink receiving surface should be dimensionally and thermally stable, i.e. it should not tear, stretch or deform, and it should be smooth and waterproof, maintain its shape and be resistant to many chemicals, and should not swell or shrink with moisture or humidity to an unacceptable degree. Further desirable properties include that the film is efficiently produced and that co-extruded layers should not delaminate. This is particularly important when forming biaxially orientated layers using the so called bubble process.

U.S. Pat. No. 4,493,872 discloses a film including a core layer having a top coating formed from a dispersion of copolyester.

WO 03/029002 discloses a shrink wrap bottle label comprising a core layer and a printable layer of copolyester. The label is reverse printed to prevent the matter printed thereon becoming damaged.

### DETAILED DESCRIPTION

It is an object of the invention to provide a polymer labelstock film having an improved inherently ink printable surface. It is a further object of the invention to overcome some of the problems described herein to provide a labelstock film substrate which is printable by printing methods such as flexo, screen and inkjet printing, for example by providing a substrate suitable for inherent printability in the absence of any topcoat layer. It is an additional object of the present invention to provide a labelstock film substrate which uses lower amounts of polymeric components than prior art arrangements without any loss in printability or film performance.

According to a first aspect of the present invention there is provided a coextruded inherently ink printable multi-layer facestock film for labels having a substrate core layer comprising a polyolefinic material, at least one skin layer which is ink printable, the ink printable skin layer comprising a copolyester and having a thickness of less than 5 μm, and a tie layer situated between the core layer and the at least one skin layer.

It has been surprisingly found that inherent ink printability can be achieved with the use of skin layers in the films of the present invention having thicknesses less than 5 μm and even with skin layers having thicknesses equal to or less than 3 μm, 2 μm, 1 μm or even 0.5 μm. By providing films including such thin layers, the amount of copolyester required is reduced, which in turn reduces production cost as well as the burden on the environment.

According to a second aspect of the present invention there is provided a coextruded inherently ink printable multi-layer facestock film for labels having a substrate core layer comprising a polyolefinic material, at least one skin layer which is ink printable, the ink printable skin layer comprising a copolyester, and a tie layer situated between the core layer and the at least one skin layer, the tie layer having a thickness of less than 5 μm.

It has unexpectedly been found that the use of a tie layer having low thickness can securely bind the polyolefinic core layer and the at least one copolyester skin layer. This is particularly surprising as the use of tie layers having a thickness of less than 10 μm was previously considered to be insufficient to prevent the delamination of coextruded polyolefinic and copolyester layers and in this connection, reference is made to, for example, U.S. Pat. No. 6,663,974. Films of the present invention have good resistance to delamination even when tie layers having thicknesses equal to or less than 3 μm, 2 μm or even 1 μm are employed. The use of such thin tie layers reduces the amount of modified polyolefin required to form the films of the present invention, which in turn reduces the cost of production and also the burden on the environment.

The film of the above first aspect may be provided with the advantageous tie layer of the film of the second aspect, i.e. it may be provided with a tie layer with a thickness of 5 μm, 3 μm, 2 μm or 1 μm. Likewise the at least one skin layer of the film of the second aspect of the present invention may have a thickness of less than 5 μm, or be equal to or less than 3 μm, 2 μm, 1 μm or 0.5 μm.

For the avoidance of any doubt, the features mentioned below in connection with the films of the present invention may be employed in films of the above first or second aspects of the present invention.

Further provided in accordance with the present invention is an adhesive containing labelstock for use in adhesive labels which comprises: a multilayer film facestock as hereinbefore described and an adhesive layer provided on the facestock.

In the labelstock film of the invention, the adhesive layer may be a pressure-sensitive adhesive layer.

The labelstock film of the invention may further comprise a release coated liner in contact with and releasably joined to the adhesive layer.

The invention also provides a label made from the aforesaid facestock, and an adhesive label die-cut from the aforesaid labelstock.

It has been found that multi-layer films for labelstock application with improved printability on a skin layer thereof can be realised by the use of a copolyester in the said skin layer. Preferably the copolyester is a preferably a reaction product of terephthalic acid, isophthalic acid or adipic acid with ethylene glycol, butanediol or hexanediol. In a preferred embodiment, the copolyester is PETG. An example of such a copolyester is Eastar 6763 from Eastman Chemicals.

The copolyester employed in films of the present invention preferably has a low degree of crystallinity. In preferred arrangements, the copolyester is amorphous.

The copolyester may in some cases be blended with other materials in the skin layer. However, the skin layer preferably comprises at least 50% copolyester, more preferably at least 80% copolyester and most preferably at least 95% copolyester.

To increase the degree of adherence between the core layer and the at least one copolyester skin, the multi-layer films of the present invention comprise at least one tie layer having compatibility with the polymeric material of the core layer and with the skin layer, the said compatibility of the tie constituent deterring delamination of the skin layer from the core layer. By “compatibility” is preferably meant that the tie constituent has an affinity, for example a chemical affinity, both for material of the skin layer and for material of the core layer.

The tie layer preferably comprises a modified polyolefin, for example, a copolymer of ethylene with an ester such as an ethylene/vinyl acetate copolymer, or an ethylene/methyl acrylate copolymer, an ethylene/n-butyl acrylate copolymer, or an ethylene/ethyl acrylate copolymer, for example, Ionomers (partially hydrolyzed ester derivatives) are also suitable comonomers. Alternatively, the tie layer may be a copolymer of ethylene and a carboxylic acid or carboxylic acid anhydride, or a terpolymer of ethylene, an ester, and a carboxylic acid or carboxylic acid or anhydride. Suitable carboxylic acids and carboxylic acid anhydrides include, but are not limited to acrylic acid, methacrylic acid, and maleic acid or maleic anhydride. Preferred modified polyolefins include ethylene/methyl methacrylate or ethylene/methacrylate/maleic acid anhydride copolymers. Such polymers are available under the trade names Admer and Lotader.

The films of the present invention may comprise a plurality of tie or skin layers. In a preferred arrangement, films may have a five layered structure, representable as A/B/C/B/A, where A is a copolyester skin layer, B is a tie layer and C is a core layer.

In an alternative arrangement, a plurality of core layers may be present. They are preferably separated by at least one polyolefinic layer formed of ethylene, propylene, butylene or copolymers thereof. A film including an olefinic layer and a plurality of core layers may have a structure representable as A/B/C/D/C/B/A, where A, B and C are as defined above and D is a polyolefinic layer.

The films of the present invention are coextruded. Coextrusion can be performed using any apparatus and techniques known to those skilled in the art. In a preferred embodiment, coextrusion is performed using the so called bubble process.

By “ink printable” is generally meant that in a standard ink pull-off tape test or UV flexo tests conducted on a film according to the invention which has been printed on its skin layer with a compatible ink and then cured (for example UV cured) and allowed to age for 24 hrs before testing, less than 50%, preferably less than 40%, more preferably less than 30%, still more preferably less than 20% and most preferably less than 10% of the ink is removed from the printed surface in the test. In a particularly preferred embodiment of the invention, less than 5%, or even as low as substantially 0%, of the ink is removed in such testing.

Also by “ink printable” is generally meant that in a standard ink pull-off tape test or UV flexo tests conducted on a film according to the invention which has been printed on its skin layer with a compatible ink and then tested immediately thereafter, less than 75%, preferably less than 60%, more preferably less than 50%, still more preferably less than 40% and most preferably less than 30% of the ink is removed from the printed surface in the test. In a particularly preferred embodiment of the invention, less than 20%, or even below 10%, of the ink is removed in such testing.

Also provided in accordance with the present invention is a polymer labelstock film in accordance with the above printed on its skin layer with at least one ink.

Further provided is a labelled article having a label prepared from the ink-printed labelstock mentioned above, wherein the ink-printed surface of the label faces outward from the article, i.e. the label is not reverse printed.

The core layer of the film may comprise additional materials such as anti-block additives, opacifiers, fillers, UV absorbers, cross-linkers, colourants, anti-static agents, antioxidants, slip additives and the like.

The tie layer of the film, when present, may comprise additional materials such as anti-block additives, opacifiers, fillers, UV absorbers, cross-linkers, colourants, anti-static agents, antioxidants, slip additives and the like.

The skin layer of the film may comprise additional materials such as anti-block additives, opacifiers, fillers, UV absorbers, cross-linkers, colourants, anti-static agents, antioxidants, slip additives and the like.

The film of the invention may be further treated, by corona discharge treating for example, further to improve ink receptivity of the film.

The surface energy of the films of the present invention is surprisingly high, which contributes to their inherent printability. The films may have a surface energy of at least 50 dynes/cm or more preferably, at least 55 dynes/cm.

The film core substrate may comprise polyethylene, polypropylene, mixtures thereof, and/or other known polyolefins.

This invention may be particularly applicable to films comprising cavitated or non-cavitated polypropylene films, with a polypropylene core and skin layers with a thickness substantially below that of the core layer.

The film may include one or more polyolefinic layers around or adjacent to the core layer, for example comprising copolymers of ethylene and propylene or terpolymers of propylene, ethylene and butylene.

The film may comprise a biaxially orientated polypropylene (BOPP) film, which may be prepared as balanced films using substantially equal machine direction and transverse direction stretch ratios, or can be unbalanced, where the film is significantly more orientated in one direction (MD or TD). Sequential stretching can be used, in which heated rollers effect stretching of the film in the machine direction and a stenter oven is thereafter used to effect stretching in the transverse direction. Alternatively, simultaneous stretching, for example, using the so-called bubble process, or simultaneous draw stenter stretching may be used.

The films of the present invention can have any degree of shrinkability. In certain arrangements, the films will be essentially non shrinkable, i.e. have a degree of shrinkability less than 20% at 100° C., more preferably less than 10% in both the machine and transverse directions. In alternative arrangements, the film will be shrinkable and/in the machine or transverse directions, making it suitable for use in shrink wrap labels for bottles, cans and other similar objects.

The films used in accordance with the present invention can be of a variety of thicknesses according to the application requirements. For example they can be from about 10 to about 240 μm thick and preferably from about 30 to about 70 μm thick.

The invention also provides processes for preparing inherently ink printable facestock films for labels.

According to a further aspect of the present invention, there is provided a process for forming an inherently ink printable facestock film for labels comprising the steps of:

a) coextruding a polyolefinic core layer, a tie layer and a copolyester skin layer to form an extrudate having at least three layers, and

b) quenching the extrudate, wherein

the copolymer skin layer is air-cooled prior to quenching step b), or wherein the tie layer extruded in step a) has a thickness of 5 μm or less.

It has surprisingly been found that the printability of copolyester can be improved if that layer, while still molten prior to quenching, is reduced in temperature using air cooling techniques.

The apparatus employed to air-cool the molten copolyester prior to quenching can take any form. In a preferred arrangement, in which the film is co-extruded in the form of a cast tube, the molten polyester is air cooled by directing a flow of air past the outer surface of the cast tube using a cylindrical or tapered baffle.

By “quenching”, reference is made to the conventionally employed step of cooling an extrudate to solidify it. Quenching is normally achieved by feeding the extrudate through one or more chill rollers or by exposing it to water.

Additionally, it has unexpectedly been found that inherently printable labelstock films which are resistant to delamination can be produced when a thin tie layer is coextruded with a polyester skin layer. Although coextruded films having relatively thin tie layers are known, these are prepared by coextruding thicker films which are then stretched, reducing the thickness of their layers including the tie layer. Stretching films by significant amounts can result in deterioration in their properties, including printability. Through the use of the processes of the present invention, the degree of stretching required to obtain a film having acceptable properties is reduced, if not eliminated.

The films of the present invention can advantageously be prepared using conventional coextrusion apparatus, although the apparatus may require re-tooling in order to produce the unusually thin skin/tie layers employed in the films of the present invention.

The invention will now be more particularly described with reference to the following examples.

### Example 1

A seven layer film according to the present invention was prepared having the structure A/B/C/D/C/B/A. The skin layers (A) were formed of amorphous PETG, available under the trade name Eastar 6763 from Eastman. Tie layers (B) were formed of methyl acrylate modified linear low density polyethylene (LLDPE), available under the trade name Admer NF912E from Mitsui. The core layers (C) were formed of propylene homopolymer, available under the trade names HP420M from Lyondell Basell or 101 GB083 from Ineos. Polyolefin layer (D) was formed of a blend of polypropylene/polyethylene and polypropylene/polybutylene copolymers, available under the trade name SPX 78J3 from Sumitomo.

Three samples of a bubble blown coextruded film including these layers were prepared. The resulting film had an overall thickness of 58 μm. The thickness of the copolyester layers (A) was 0.3 μm per layer while the thickness of the tie layers (B) was 0.8 μm per layer. One of the skin layers (A) was corona discharge treated.

As will be seen below, despite the thinness of the skin and tie layers, advantageous results were achieved.

### Inherent Printability

Standard (QC) UV screen ink was used to test the film's printability. A high degree of printability was achieved for all samples. Further, the film also passed ice chest and pasteurisation tests. This high level of printability was not expected, nor the high surface energies of greater than 58 dynes/cm.

TABLE 1

| | Pull | | Ice Chest | | | | | | | Surface |
|---|---|---|---|---|---|---|---|---|---|---|
| | Off | | Initial | | | | Pasteurisation | | | Energy |
| Sample | (%) | Scratch | Damage | Easy | Moderate | Hard | Easy | Moderate | Hard | (dyne/cm) |
| 1 | 0 | Pass | None | 0 | 0 | 1 | 0 | 0 | 2 | >58 |
| 2 | 0 | Pass | None | 0 | 0 | 1 | 0 | 0 | 1 | >58 |
| 3 | 0 | Pass | None | 0 | 0 | 1 | 0 | 0 | 1 | >58 |

### Metal Adhesion

The film of the present invention was tested for metal adhesion. A4 samples were metallised on their corona treated side before being subjected to a standard tape test. Samples were also heat sealed together with metallised side to non-treated copolyester side.

| | Metal | | | | | | | | |
|---|---|---|---|---|---|---|---|---|---|
| | Pull-Off | Metal Adhesion, Heat Seal (% removed) | | | | | | | |
| Sample | (%) | 70 | 80 | 90 | 100 | 110 | 120 | 130 | 140 |
| 1 | 1 | 0 | 0 | 0 | 0 | 1 | 2 | 5 | 5 |
| | | 0 | 0 | 0 | 1 | 1 | 2 | 5 | 10 |
| 2 | 2 | — | — | — | — | — | — | — | — |
| | | — | — | — | — | — | — | — | — |
| 3 | 1 | 0 | 0 | 0 | 0 | 0 | 2 | 5 | 2 |
| | | 0 | 0 | 0 | 0 | 0 | 5 | 5 | 10 |

As can be seen from the data, the metal pull-off via standard tape test is <5% and the metal removed following heat seal does not reach 10% until a temperature of 140° C. This shows the copolyester film to have excellent metal adhesion properties.

1. A coextruded inherently ink printable multi-layer facestock film for labels having a substrate core layer comprising a polyolefinic material, at least one skin layer which is ink printable, the ink printable skin layer comprising a copolyester, and at least one tie layer situated between the core layer and the at least one skin layer, wherein the at least one skin layer and/or the at least one tie layer have a thickness of less than 5 μm.

2. The film of claim 1, wherein the at least one skin layer and/or the at least one tie layer have a thickness of less than 3 μm.

3. The film of claim 1, wherein the at least one skin layer and/or the at least one tie layer have a thickness of less than 2 μm.

4. The film of claim 1, wherein the at least one skin layer and/or the at least one tie layer have a thickness of less than 1 μm.

5. The film of claim 1, wherein the at least one skin layer has a thickness of less than 0.5 μm.

6. The film of claim 1, wherein the copolyester is amorphous.

7. The film of claim 1, wherein the copolyester is PETG.

8. The film of claim 1, wherein the at least one skin layer comprises at least 80% copolyester.

9. The film of claim 1, wherein the at least one skin layer comprises at least 95% copolyester.

10. The film of claim 1, wherein the tie layer comprises a modified olefin polymer.

11. The film of claim 10, wherein the modified olefin polymer is modified ethylene.

12. The film of claim 11, wherein the modified ethylene polymer is modified with acrylates and/or anhydrides.

13. The film of claim 11, wherein the modified ethylene polymer is modified with methyl acrylate and/or maleic acid anhydride.

14. The film of claim 1, wherein the polyolefinic core layer comprises polypropylene homopolymer.

15. The film of claim 1, wherein the film, when printed with ink on the skin layer, will not shed more than 30% of the ink when subjected to a standard ink pull-off test.

16. The film of claim 1, comprising one or more additional materials selected from the group consisting of anti-block additives, opacifiers, fillers, UV absorbers, cross-linkers, colourants, anti-static agents, antioxidants, anti-haze agents, slip additives and combinations of two or more thereof.

17. The film of claim 1, further treated to improve ink receptivity of the skin layer.

18. The film of claim 17, wherein the further treatment comprises corona discharge treatment.

19. The film of claim 1, having a thickness of from about 40 μm to about 240 μm.

20. The film of claim 1, printed on the at least one skin layer with at least one ink.

21. A labelstock film for adhesive labels, comprising: a multilayer film facestock in accordance with claim 1; and an adhesive layer provided on the facestock.

22. The labelstock film according to claim 21, wherein the adhesive layer is a pressure-sensitive adhesive layer.

23. The labelstock film according to claim 21, further comprising a release coated liner in contact with and releasably joined to the adhesive layer.

24. The labelstock film according to claim 21, further comprising a release coated liner in contact with and releasably joined to the adhesive layer.

25. An adhesive label die-cut from the film of claim 1.

26. A labelled article having the label of claim 25 applied thereto.

27. The article of claim 26, arranged such that the surface of the at least one outer skin is not in contact with the surface of the article.

28. A process for forming an inherently ink printable facestock film for labels, comprising the steps of:
a) coextruding a polyolefinic core layer, a tie layer and a copolyester skin layer to form an extrudate having at least three layers: and
b) quenching the extrudate,
wherein the copolymer skin layer is air-cooled prior to quenching step b), or wherein the tie layer extruded in step a) has a thickness of 5 μm or less.
